(19) United States
(12) Patent Application Publication
(10) Pub. No.: US 2025/0204714 A1
(43) Pub. Date: Jun. 26, 2025

(54) COOKING METHOD FOR MAKING RICE BY USING COOKING UTENSIL, AND COOKING UTENSIL

(71) Applicant: JOYOUNG COMPANY LIMITED, Jinan (CN)

(72) Inventors: Zechun ZHU, Jinan (CN); Weimin CUI, Jinan (CN); Yuan WANG, Jinan (CN); Huiping JIANG, Jinan (CN); Shuangyang CHEN, Jinan (CN); Sheng XU, Jinan (CN)

(21) Appl. No.: 18/846,660

(22) PCT Filed: Dec. 7, 2022
(86) PCT No.: PCT/CN2022/137213

§ 371 Date: Sep. 13, 2024

(30) Foreign Application Priority Data
Mar. 14, 2022 (CN) 202210246880.5
Mar. 29, 2022 (CN) 202210317381.0

(51) Int. Cl. A47J 27/08; A47J 36/32

(52) U.S. Cl. CPC A47J 27/0802; A47J 36/32

(57) ABSTRACT

A cooking method for making rice by using a cooking utensil, and a cooking utensil. The cooking method comprises the following steps: acquiring a rice cooking instruction, executing a preset cooking curve until a rice stewing stage, and finding out an execution state of the rice stewing stage (S01); and when the execution state meets a preset condition, controlling a cooking utensil to enter an elasticity-increasing stage, wherein the elasticity-increasing stage comprises controlling a cooling apparatus to cool rice in an inner pot (30), and the temperature of the rice decreases by a preset temperature and/or a cooling time reaches a preset time, such that the rice is cooled to shrink (S02). The cooking utensil comprises an inner pot (30) used for cooking rice, a heating apparatus (105), and a cooling apparatus capable of cooling an outer side wall of the inner pot (30). By means of cooling processing, a temperature state of an environment where rice grains are located is changed, such that the rice grains have the characteristics that the rice grains can elastically deform under a certain pressure, and that the shape of the rice grains can be maintained; therefore, the rice grains taste chewier.

The present application is a National Phase entry of PCT Application No. PCT/CN2022/137213, filed on Dec. 7, 2022, which claims the priorities to following Chinese Patent Applications:
1) Chinese Patent Application No. 202210246880.5, titled “COOKING METHOD FOR MAKING RICE BY USING COOKING UTENSIL, AND COOKING UTENSIL”, filed with the China National Intellectual Property Administration on Mar. 14, 2022; and
2) Chinese Patent Application No. 202210317381.0, titled “COOKING METHOD FOR MAKING RICE BY USING COOKING UTENSIL, AND COOKING UTENSIL”, filed with the China National Intellectual Property Administration on Mar. 29, 2022;
the entire disclosures of which are incorporated herein by reference.

### FIELD

The present application relates to the field of kitchen appliance, and in particular to a cooking method for making rice using a cooking utensil and the cooking utensil.

### BACKGROUND

In the existing rice cooking, the cooking method of the rice cooker generally includes a water absorption stage, a heating stage, a boiling stage, a stewing stage, and a heat preservation stage. The water absorption stage is used to promote rice starch absorbing water and rice gelatinization, to prevent the rice from being half-cooked; the heating stage is used to quickly heat the rice to boiling after the water absorption is completed, and the boiling stage is used to cook the rice at high temperature; the stewing stage is used to further stew the rice after the rice being cooked, and cooked rice absorbs more water, making cooked rice more tasty, dry and chewy; after the stewing stage is over, the lid can be opened and cooked rice can be taken out, indicating that the cooking process is completed, and then the heat preservation stage is entered. The heat preservation stage is used to prevent the cooked rice from cooling down, so the temperature of cooked rice is maintained.

The rice after experiencing the stewing stage is basically well cooked, but under the existing cooking method, the elasticity of the cooked rice at this stage is not ideal.

### SUMMARY

The present application provides a cooking method and a cooking utensil for making rice with a cooking utensil, to solve the problem of poor elasticity of rice with the cooking utensil.

The embodiment of the present application is implemented as follows.

On one hand, an embodiment of the present application provides a cooking method for making rice with a cooking utensil, the cooking utensil includes an inner pot for cooking rice, a heating device and a cooling device, and the cooking method includes the following steps:
obtaining a preset cooking instruction, executing a preset cooking curve to a rice stewing stage, and acquiring an execution status in the rice stewing stage;
when the execution status meets preset conditions, controlling the cooking utensil to enter an elasticity-increasing stage;
specifically, the elasticity-increasing stage includes controlling the cooling device to cool the rice in the inner pot, the temperature of the rice drops to a preset temperature and/or the cooling time reaches a preset time, and the rice shrinks due to cold.

On the other hand, an embodiment of the present application provides a cooking device, including an inner pot for cooking rice, a heating device, a cooling device capable of cooling an outer wall of the inner pot, a memory and a processor, and the memory stores a computer program that can be run on the processor; the processor implements the steps in the above method when executing the program.

In the embodiment of the present application, by determining the execution status of the rice stewing stage and controlling the cooking utensil to enter the elasticity-increasing stage when the execution status meets the preset conditions, the elasticity of the rice that is completely gelatinized in the rice stewing stage can be improved. During the rice stewing stage, the moisture in the rice is reduced, and the remaining small amount of rice-water is distributed among the gaps of the rice. Under high temperature, part of the moisture is absorbed by the rice grains, and part of the moisture evaporates. In order to prevent the rice grains from continuing to absorb moisture and maintain the shape of the rice grains, in some embodiments of the present application, the rice in the inner pot is cooled by a cooling device. During the cooling process, the temperature state of the environment in which the rice grains are located is changed, and the rice is changed from being hot outside and cold inside to being cold outside and hot inside. Under such a temperature state, outer surfaces of the rice grains are first cooled and contracted, and interiors of the rice grains are then cooled and contracted. In this way, when the rice grains shrink unevenly, internal stress may be generated inside and act on the outer surfaces of the rice grains to make the outer surfaces of the rice grains become compact. The compact appearance hinders the rice from further absorbing water, and the rice is not too soft. In addition, since the rice grains have been gelatinized, the compact appearance is a fluffy structure, which makes the rice grains have a certain elastic deformation ability. In summary, in this way, the rice grains can have the characteristics of being able to produce elastic deformation under a certain pressure and the shape of the rice grains can be maintained, and the taste is chewier.

### BRIEF DESCRIPTION OF THE DRAWINGS

The drawings described herein are used to provide further understanding of the present application and constitute a part of the present application. The illustrative embodiments of the present application and their descriptions are used to explain the present application and do not constitute improper limitations on the present application. In the accompanying drawings:

FIG. 1 is a flow chart of an embodiment of a cooking method for making rice using a cooking utensil provided in a first example of the present application;

FIG. 2 is a flow chart of obtaining the execution status by the execution duration of the stewing rice stage provided in the first example of the present application;

FIG. 3 is a flow chart of the temperature value after the cooling process provided in the first example of the present application;

FIG. 4 is a flow chart of the execution of the cooling device provided in the first example of the present application;

FIG. 5 is a flow chart of the execution of the elasticity-increasing stage provided in the first example of the present application;

FIG. 6 is a structural block diagram of the cooking utensil provided in the first example of the present application;

FIG. 7 is a structural schematic diagram of the cooking utensil provided in the first example of the present application;

FIG. 8 is a flow chart of an embodiment of a cooking method for making rice using the cooking utensil provided in a second example of the present application;

FIG. 9 is a graph of the working temperature of the air supply device during the cooling process provided in the second example of the present application;

FIG. 10 is a graph of the working temperature of the air supply device during the cooling and heating process provided in the second example of the present application;

FIG. 11 is a graph of the entire rice cooking process provided in the second example of the present application;

FIG. 12 is a structural block diagram of the cooking utensil provided in the second example of the present application.

in which:
10 rice cooker body; 101 heat preservation inner cover; 105 heating device; 106 storage cavity;
20 pot lid;
30 inner pot; 301 cooking cavity;
40 cooling fan (fan).

### DETAILED DESCRIPTION OF THE EMBODIMENTS

In order to more clearly explain the overall concept of the present application, the following is a detailed description in combination with the drawings of the specification by way of example.

In the following description, many specific details are described to facilitate a full understanding of the present application. However, the present application can also be implemented in other ways different from those described herein. Therefore, the scope of protection of the present application is not limited by the specific embodiments disclosed below.

In addition, in the description of the present application, it should be understood that the orientation or position relationship indicated by the terms “inside” and “outside” is based on the orientation or position relationship shown in the drawings, which is only for the convenience of describing the present application and simplifying the description, rather than indicating or implying that the device or element referred to must have a specific orientation, be constructed and operated in a specific orientation, and therefore cannot be understood as a limitation of the present disclosure.

In the present application, unless otherwise clearly specified and limited, the terms “installed”, “connected”, “connected”, “fixed” and the like should be understood in a broad sense, for example, it can be a fixed connection, a detachable connection, or an integral connection; it can be a mechanical connection, an electrical connection, or a communication; it can be directly connected, or indirectly connected through an intermediate medium, it can be the internal connection of two elements or the interaction relationship between two elements. For ordinary technicians in this field, the specific meanings of the above terms in the present disclosure can be understood according to the specific circumstances.

In this application, unless otherwise clearly specified and limited, the first feature “on” or “under” the second feature can be the first and second features directly contacting, or the first and second features indirectly contacting through an intermediate medium. In the description of this specification, the description of the reference terms “implementation method”, “example”, “one embodiment”, “example” or “specific example” means that the specific features, structures, materials or characteristics described in conjunction with the embodiment or example are included in at least one embodiment or example of this application. In this specification, the schematic representation of the above terms does not necessarily refer to the same embodiment or example. Moreover, the specific features, structures, materials or characteristics described can be combined in an appropriate manner in any one or more embodiments or examples.

First, this application is made based on the following understanding and discovery of the inventor.

The main ingredient of rice is starch. The so-called cooking is the process of fully gelatinizing the ordered β-structured starch into disordered α-structured starch through water and heating. The higher the α-degree (gelatinization degree) of the rice is, the larger the expansion rate of the rice is, and the water absorption rate thereof is also increased, and the corresponding elasticity is decreased. In layman's terms, the cooked rice may be softer.

Rice starch includes amylopectin and amylose. The higher the amylopectin content is, the greater the viscosity of the rice is. After steaming process, rice grains expand greatly and appear full and round. The high amylose content can make the cooked rice hard and inelastic. At present, most of the rice consumed in households is japonica rice or indica rice. Specifically, the proportion of amylose in indica rice is high, which can be up to 20%-24%, and the proportion of amylose in japonica rice is low, which can be up to about 15%-18%. It can be seen that no matter what kind of rice, there always is a certain proportion of amylose.

The good elasticity of rice can be regarded as that the rice grains can produce elastic deformation under a certain pressure and the shape of the rice grains can be maintained.

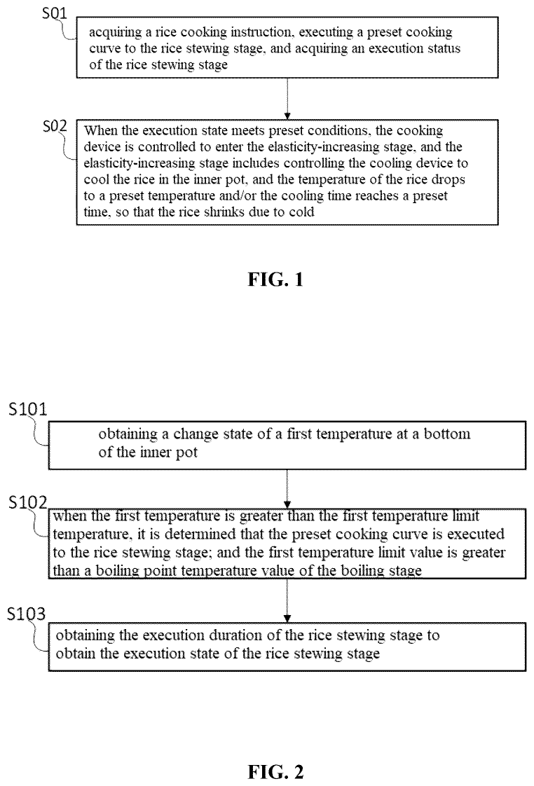

Referring to FIG. 1, a process of an embodiment of a cooking method for making rice according to a cooking utensil provided in the present application is shown, and the cooking method of rice is applied to a cooking utensil that can cook rice; the cooking utensil may include but is not limited to an electric rice cooker, an electric stew pot, an electric pressure cooker, an air fryer, etc. In the following cooking method, the cooking utensil includes an inner pot for cooking rice, a heating device, and a cooling device that can cool the rice, as described below.

The cooking method includes the following steps.
S01: acquiring a rice cooking instruction, executing a preset cooking curve to the rice stewing stage, and acquiring an execution status of the rice stewing stage.

Here, the cooking instruction may be but is not limited to an operation instruction issued by touching the operation panel or display panel of the cooking utensil, a remote control instruction issued by an infrared remote controller or a remotely controllable device, and a remote control instruction issued by a remote server.

The preset cooking curve can complete the cooking of rice. The preset cooking curve can be but not limited to be stored in a cooking utensil memory, a remote server, or an intelligent terminal. For rice cooking, the preset cooking curve generally includes a water absorption stage, a temperature rise stage, a boiling stage, a rice stewing stage, and a heat preservation stage.

The execution state of the rice stewing stage can be but not limited to the following means.
1) Referring to FIG. 2, the execution state is obtained by an execution duration of the rice stewing stage;
S101: obtaining a change state of a first temperature at a bottom of the inner pot;
S102: when the first temperature is greater than the first temperature limit temperature, it is determined that the preset cooking curve is executed to the rice stewing stage; and the first temperature limit value is greater than a boiling point temperature value of the boiling stage;
S103: obtaining the execution duration of the rice stewing stage to obtain the execution state of the rice stewing stage.

The first temperature can be obtained by a bottom temperature sensor arranged on the cooking utensil. Specifically, in one embodiment, the bottom temperature sensor is an NTC thermistor, which abuts against the bottom of the metal inner pot and can convert the temperature data of the inner pot into an electrical signal. In addition, in order to facilitate the acquisition of the boiling point temperature value, it can be obtained through the top temperature sensor arranged on the cooking utensil. Specifically, in one embodiment, the top temperature sensor is an NTC thermistor, which is arranged on the pot lid of the cooking utensil, and a probe is inserted into the cooking cavity formed by the inner pot and the pot lid. The temperature data in the cooking cavity is obtained and converted into an electrical signal to obtain the boiling point temperature value. Here, the top temperature data can be referred to as a second temperature.

After the boiling stage is executed for a period of time, the water in the pot is gradually evaporated or absorbed by the rice grains, causing the first temperature at the bottom of the inner pot to be higher than the boiling point. At this time, the first temperature limit value can be 120° C.-130° C. After entering the stewing rice stage, the execution status of the stewing rice stage can be known by the execution duration of the stewing rice stage.

At the same time, in some specific embodiments, step S103 can also be:
obtaining the change state of the first temperature at the bottom of the inner pot in the stewing rice stage to determine the execution status of the stewing rice stage.

In the rice stewing stage, the rice is maintained at a certain temperature value, such as 105° C., 110° C., and the moisture of the rice continues to shrink and the rice grains continue to gelatinize. The first temperature of the inner pot is always in a certain fluctuation. At this time, the change state of the first temperature in the rice stewing stage can be used to identify whether the inner pot is in a heating or cooling state and the current temperature value in the rice stewing stage.
2) the execution state is obtained through the state of the heating device in the rice stewing stage;
obtaining the heating state of the heating device;
when the heating device stops heating for a longer time than a first duration threshold, the execution state of the rice stewing stage is known.

In the rice stewing stage, the heating state of the heating device can indirectly represent the execution state in the rice stewing stage. When the rice stewing stage is over, the heating device stops heating. At this time, the heating device stops heating for a longer duration than the heating device stops heating in the rice stewing stage.
S02: When the execution state meets preset conditions, the cooking device is controlled to enter the elasticity-increasing stage, and the elasticity-increasing stage includes controlling the cooling device to cool the rice in the inner pot, and the temperature of the rice drops to a preset temperature and/or the cooling time reaches a preset time, and the rice shrinks due to cold.

After the stewing stage, the rice is basically well cooked, but under the existing cooking method, the elasticity of the rice at this stage is not ideal, especially for rice with a high proportion of amylose, the cooked rice is mostly hard; this is because after this stage, the gelatinization degree of starch particles is relatively large, and the rice grains absorb water and swell, becoming soft; during the gelatinization process of rice, the amount and time of outside of the rice grains contacting with water is relatively long, and the amount and time of inside of the rice grains contacting with water is relatively small, so the gelatinization degree of the starch on the outside of the rice grains is more thorough, while the gelatinization degree of the inside is relatively small, because under the existing cooking method, the gelatinization degree of the rice grains is large on the outside and small on the inside, and in terms of taste, it does not have the characteristics of being able to produce elastic deformation under a certain pressure and the shape of the rice grains being able to be maintained.

By determining the execution status of the rice stewing stage and controlling the cooking utensil to enter the elasticity-increasing stage when the execution status meets the preset conditions, the elasticity of the rice that is relatively completely gelatinized during the rice stewing stage can be improved.

During the rice stewing stage, the water content in the rice is reduced, and the remaining small amount of rice-water is present in the gaps of the rice grains. Under high temperature, part of the water is absorbed by the rice grains, and part of the water evaporates. In order to prevent the rice grains from continuing to absorb water and maintain the shape of the rice grains, in some embodiments of the present application, the rice in the inner pot is cooled by a cooling device. Under the cooling process, the temperature state of the environment in which the rice grains are located is changed, and the rice changes from the original hot outside and cold inside to cold outside and hot inside. Under such a temperature state, the outer surfaces of the rice grains are first cooled and contracted, and the interiors of the rice grains are cooled and contracted later. In this way, when the rice shrinks unevenly, internal stress may be generated inside and act on the outer surfaces of the rice grains to make the outer surfaces of the rice grains compact. The compact appearance prevents the rice from further absorbing water, and the rice is not too soft. In addition, since the rice grains have been gelatinized, the compact appearance encloses a fluffy structure, which makes the rice grains have a certain elastic deformation ability. In summary, the rice grains can have the characteristics of being able to produce elastic deformation under a certain pressure and the shape of the rice grains can be maintained, and the taste is more elastic.

In some specific embodiments of the present application, the cooling position of the cooling device may be but is not limited to the outer wall of the inner pot or the outer space of the inner pot or the inner space of the inner pot, and the cooling device may be but is not limited to water cooling, air cooling, semiconductor cooling or other cooling devices.

Taking air cooling as an example, the experimental data are as follows:

| | | | Elasticity |
|---|---|---|---|
| Rice sample | Hardness (score) | Viscosity (score) | index (score) |
| Experimental group | 4306 (80) | 13.6 (100) | 0.48 (100) |
| Comparison group | 4016(60) | 11.1 (100) | 0.44(60) |

The experimental group includes parameters of rice after air cooling; the control group includes parameters of rice without air cooling. It can be seen that the elasticity index of the experimental group is 9% higher than that of the Comparison group.

When the execution state meets the preset conditions, the cooking utensil is controlled to enter the elasticity-increasing stage, and the preset conditions include: when the stewing stage is over. At the end of the rice stewing stage, the heating device can be controlled to stop heating the inner pot, and the rice can be quickly cooled by the hot and cold cooling device, and the temperature state of the rice can be changed as soon as possible, to increase the elasticity. With the end of the rice stewing stage being as the preset condition of the execution state, there may be no situation where the heating device continues to resume heating after the cooling process to continue to complete the rice stewing stage. At this time, if the heating is resumed when the temperature after the cooling process is low, the heating process may cause the temperature state of the rice grains to change, to reduce the elasticity of the rice grains. After the rice stewing is completed, the cooling process is performed, which means that the heating device does not need to resume heating after the cooling process, and the elasticity of the rice grains can be maintained.

In one embodiment of the present application, as described in S103, whether the rice stewing stage is over can be obtained by the execution duration of the rice stewing stage. When the execution duration of the rice stewing stage is known, the end time of the rice stewing stage can be determined according to the execution duration, to control the cooking utensil to enter the elasticity-increasing stage. In the alternative solution of S103, whether the rice stewing stage is over can be known by the change state of the first temperature in the rice stewing stage. When the cooking time increases, the moisture in the rice continues to decrease. For this reason, the change rate of the first temperature may gradually increase. By identifying the change rate of the first temperature, the end time of the rice stewing stage can be identified. In another embodiment, whether rice stewing stage is in the end time of the rice stewing stage can be determined by the duration of the heating device stopping heating.

In some embodiments of the present application, the preset condition can be that when the rice stewing stage is executed to the preset time, cooling process is performed; at this time, the preset time can be less than ⅓ of the total duration of the rice stewing stage, that is, when the rice stewing stage is executed for more than ⅔ of the total time, cooling process is performed to increase the elasticity. In one embodiment, during and after the cooling process, the heating device stops heating.

In some embodiments of the present application, the preset condition can also be that when the first temperature at the bottom of the inner pot reaches the preset temperature during the rice stewing stage, a cooling process is performed; during the rice stewing stage, the heating device heats the inner pot to maintain a certain temperature, such as 105° C., 110° C. During this process, the heating device intermittently heats the inner pot at a power of 100 W-500 W, and the temperature of the rice is in a relatively stable process. In order to improve elasticity, when the temperature reaches 105° C., 110° C., the heating device stops heating, and the cooling process can be started at this time to form a cold and hot shock to the rice to improve elasticity. When the temperature drops to a certain temperature, the cooling process is stopped and the heating device resumes heating. In one embodiment, the temperature drop should not be too much, preferably 3° C.-10° C., not to affect the stewing effect of the rice. Finally, it is preferred to perform a cooling process after the rice stewing stage is completed, to overcome the problem of stress fading after heating.

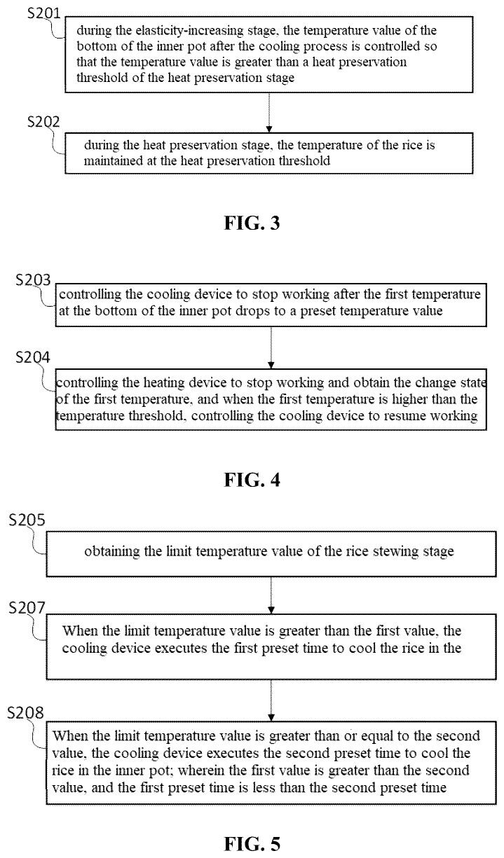

In some embodiments of the present application, after the cooling device cools the rice, it is necessary to maintain a certain temperature for easy to eat. For this purpose, the preset cooking curve includes a heat preservation stage. In the prior art, the rice is maintained at a certain temperature during the heat preservation stage. Referring to FIG. 3, the cooking method further includes the following steps:
S201: during the elasticity-increasing stage, the temperature value of the bottom of the inner pot after the cooling process is controlled and the temperature value is greater than a heat preservation threshold of the heat preservation stage;
S202: during the heat preservation stage, the temperature of the rice is maintained at the heat preservation threshold.

When there is the heat preservation stage, it means that the heating device needs to resume heating. At this time, if the temperature value after the cooling process is lower than the heat preservation threshold, then in the heat preservation stage, the temperature rise process must make the temperature exceed the temperature value after the cooling process, which may cause the temperature state of the rice grains to change, to cause the elasticity of the rice grains to decrease; if the temperature value after the cooling process is controlled to be greater than the heat preservation threshold of the heat preservation stage, the temperature rise amplitude of the rice after the cooling process during the heat preservation stage is small, and the negative effect is also small, so the elasticity of the rice can be maintained. For example, the temperature value after cooling is 80° C., and the insulation threshold is 70° C., which is greater than the insulation threshold.

The above-mentioned “controlling the temperature value of the bottom of the inner pot after the cooling process and the temperature value is greater than the insulation threshold of the insulation stage” can be achieved by, but not limited to, the following means: 1) by controlling the execution duration of the cooling device; 2) by setting a lower limit of the falling temperature, controlling the cooling device to stop working when the first temperature exceeds the lower limit; 3) by controlling the power of the cooling device, for example, when the cooling device is a cooling fan, the power can be adjusted by controlling the speed of the cooling fan or an intermittent operation.

Further, in some embodiments of the present application, during the cooling process, there is a natural cooling stage between the heat preservation stage and the elasticity-increasing stage, and in the natural cooling stage, the first temperature of the bottom of the inner pot is naturally cooled from the temperature value after the elasticity-increasing stage to the heat preservation threshold.

Through the natural cooling stage, the inner pot and the rice can dissipate heat evenly, to improve the uniformity of the temperature of the rice. At the same time, during the cooling process, the temperature drops too quickly. The natural cooling stage can avoid the possibility that the temperature value after the elasticity-increasing stage is lower than the heat preservation threshold, and then avoid needing a large temperature increase in the heat preservation stage and thus producing negative effects.

It should be noted that during the natural cooling stage, both the cooling device and the heating device do not work, and the natural cooling stage simply relies on the environment to dissipate heat naturally.

The above-mentioned heat preservation threshold can be 60° C.-70° C., and the temperature value after cooling process can be 70° C.-98° C. In one embodiment, the temperature after cooling in the elasticity-increasing stage cannot be too low to prevent the internal expansion of the rice from the impact of temperature, and the residual stress of the cooling process is released, and the surface of the rice grains cannot be kept tight and the elasticity thereof is reduced. Further, the temperature of the rice drops to a preset temperature, which is 3° C. to 10° C.; the cooling time reaches a preset time, which is 2 to 10 minutes.

It should be noted that some cooking utensils have a display interface, which can display the time when cooking ends and the duration of heat preservation. At this time, it should be understood that the end time which is displayed can be the time of the rice stewing stage plus the elasticity-increasing stage, or only the time of the rice stewing stage, or the time of the rice stewing stage plus the elasticity-increasing stage plus the natural cooling stage; similarly, the duration of heat preservation can be the time of the elasticity-increasing stage plus the heat preservation stage, or only the heat preservation stage, or the time of the natural cooling stage plus the elasticity-increasing stage plus the heat preservation stage.

In some embodiments of the present application, the cooling device cools an outer space, an inner space or an outer wall of the inner pot. Since the inner pot contains rice, cooling cannot directly reach the interior of the rice in a short time. In order to improve the uniformity of cooling and avoid uneven cooling, under the cooling process, referring to FIG. 4, the execution of the control of the cooling device includes the following steps:
S203: controlling the cooling device to stop working after the first temperature at the bottom of the inner pot drops to a preset temperature value;
S204: controlling the heating device to stop working and obtain the change state of the first temperature, and when the first temperature is higher than the temperature threshold, controlling the cooling device to resume working.

The above steps can be repeated. For example, when the preset temperature value is 80° C., after one cooling process, part of the heat of the rice is taken away. As the inner pot is metal, the temperature thereof can change quickly. Therefore, when the first temperature at the bottom of the inner pot drops to 80° C., cooling can be stopped and heating can be stopped at the same time. At this time, the rice is in the process of natural heat dissipation. Under the effect of residual heat, the temperature may further recover. When the first temperature is higher than the temperature threshold, the cooling device can be controlled to resume work. Here, the temperature threshold can be 80° C. or less than 80° C., that is, the temperature threshold can be equal to or less than the preset temperature value. Such treatment can improve the uniformity of the cooling process and make the rice more elastic.

In some embodiments of the present application, the limit temperature values of the rice stewing stage may be different, such as 105° C., 110° C., etc.; for this reason, referring to FIG. 5, when the elasticity-increasing stage is executed, the following steps are proposed:
S205: obtaining the limit temperature value of the rice stewing stage;
S206: when the limit temperature value is greater than the first value, the cooling device executes the first preset time to cool the rice in the inner pot;
S207: when the limit temperature value is greater than or equal to the second value, the cooling device executes the second preset time to cool the rice in the inner pot; and the first value is greater than the second value, and the first preset time is less than the second preset time.

Based on different limit temperature value sizes, different cooling times are executed for the cooling device. In the above method, during the cooling process, the cooling time of the cooling device is controlled, not the temperature. This avoids the problem of too long cooling time due to the need to drop to the same temperature value under different limit temperature values, to improve the user's product experience. For example, if the limit values are 105° C. and 110° C., the first value is 100° C., and the second value is 110° C., then when the limit temperature value is 105° C., the cooling device may execute for 5 minutes (first preset time), and when the limit temperature value is 110° C., the cooling device will execute for 10 minutes (second preset time).

In some embodiments of the present application, the cooling device includes a cooling fan, and the control of the cooling fan includes:
controlling the cooling fan to work at a preset speed to cool the outer wall of the inner pot.

The cooling fan has low cost, and the cold air acts more evenly on the outer wall of the inner pot. The preset speed can be 1500 r/min-10000 r/min, and the noise of the cooling fan during operation can be controlled within a reasonable range, improving the user experience.

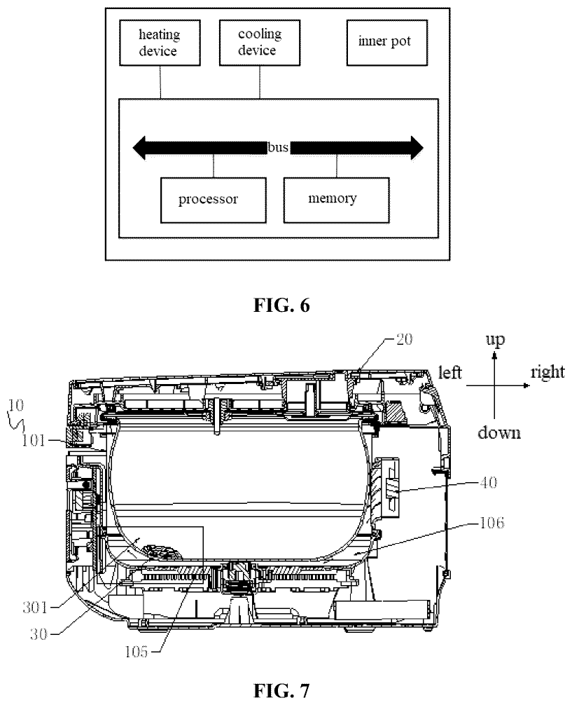

In some embodiments of the present application, referring to FIG. 6, a cooking utensil is also proposed, including an inner pot for cooking rice, a heating device, and a cooling device capable of cooling the outer wall of the inner pot, as well as a memory and a processor, and the memory stores a computer program that can be run on the processor; when the processor executes the program, the steps in the method described in any one of the above claims are implemented.

In one embodiment, the heating device may be an electromagnetic heating coil, and the inner pot is heated by the alternating magnetic field generated by the electromagnetic heating coil. In another embodiment, the heating device may be a heating plate, and the internal heating tube is energized to generate heat, and then the heat is transferred to the rice in the inner pot through heat conduction.

Referring to FIG. 7, a structural diagram of an embodiment of the electric rice cooker according to the present application is shown; the rice cooker includes a rice cooker body 10, a pot lid 20, a heat-insulating inner cover 101, an inner pot 30 for cooking rice, a heating device 105, and a cooling fan 40. The rice cooker body 10 is provided with a receiving cavity 106, and the inner pot 30 is placed in the receiving cavity 106 and on the heating device 105. The pot lid 20 is buckled to close the receiving cavity 106 and the inner pot 30 to form a cooking cavity 301; the cooling fan 40 here can inhale cold air to cool the inner pot 30.

In some embodiments of the present application, the inner pot includes an inner wall formed by a metal layer; the inner wall is provided as a metal layer to improve the thermal conductivity of the inner pot when the heating device heats the inner pot.

In the prior art, the inner wall of the inner pot is generally sprayed with a non-stick coating made of polytetrafluoroethylene material. The thermal conductivity of Teflon material is low, about 0.256 W/(mk), while the thermal conductivity of metal is generally between 30-400 W/(mk), so the non-stick coating reduces the heating performance to a certain extent, to affect the temperature change efficiency of cooling and heating treatments, and thus showing a more significant elasticity-increasing effect.

First, this application is based on the following understandings and discoveries of the inventor.

Based on a space kitchen project that Applicant participated in the research and development, Applicant invented a hot air heating device for the space capsule to solve the needs of astronauts to heat food in the space capsule, the applicant further studied the hot air precise temperature control technology and applied it to small kitchen appliances, resulting in the hot air precise temperature control cooking process of the present application, which greatly improved the water absorption consistency of rice and improved the taste of rice.

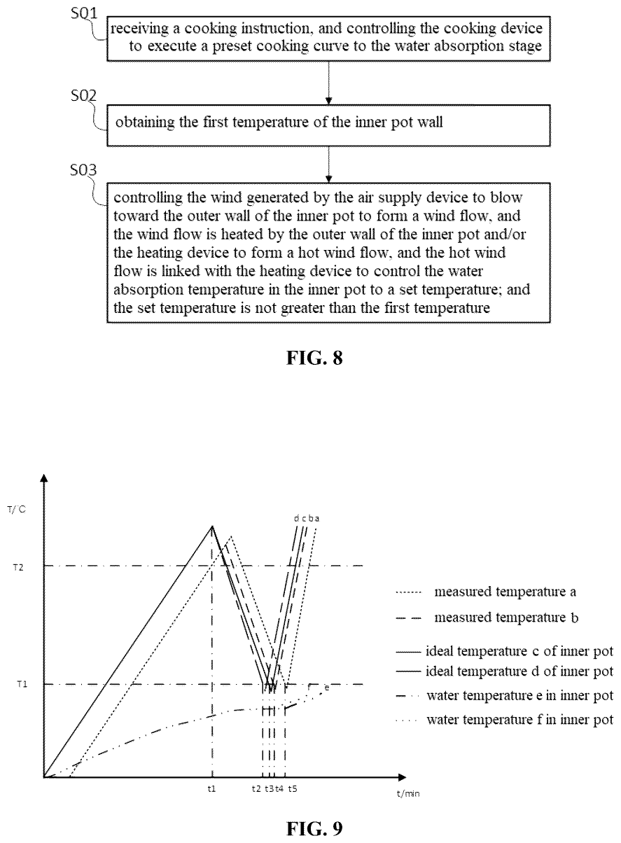

Referring to FIG. 8, a flow chart of an embodiment of a control method for cooking rice using a cooking utensil disclosed in the present application is shown, and the control method for cooking rice is applied to a cooking utensil capable of cooking rice; the cooking utensil may include but is not limited to an electric rice cooker, an electric pressure cooker, etc. In the following control method, the cooking utensil includes an inner pot for cooking rice, a bottom temperature sensor, a heating device, and an air supply device, as described below.

The cooking method includes:
S01: receiving a cooking instruction, and controlling the cooking device to execute a preset cooking curve to the water absorption stage;
here, the cooking instruction may be, but is not limited to, an operation instruction issued by touching the operation panel or display panel of the cooking device, a remote control instruction issued by an infrared remote controller or a remotely controlled device, or a remote control instruction issued by a remote server.

The preset cooking curve can complete the cooking of rice, and the preset cooking curve may be, but is not limited to, stored in the cooking device memory, in the remote server, or in the smart terminal; for rice cooking, the preset cooking curve generally includes a water absorption stage, a heating stage, a boiling stage, a stewing stage, a heat preservation stage, etc.

The purpose of the water absorption stage is to keep the water temperature of the rice in the inner pot at the water absorption temperature for a certain period of time, and the rice absorbs water slowly, and control the uniformity of the water temperature of the rice, to avoid the water temperature of some rice being too high, resulting in gelatinization of the rice grains, and thus making the water absorption rate, hardness, viscosity, elasticity, etc. of the rice better.

Ideally, the water absorption temperature of the rice in the inner pot should not exceed 55° C., preferably, it is best to maintain at 43° C.-45° C., and the starch of the rice grains can be hindered from α-forming, to ensure the uniformity of the water absorption of the rice.
S02: obtaining the first temperature of the inner pot wall;

The first temperature can be obtained by a bottom temperature sensor provided on the cooking utensil. Specifically, in one embodiment, the bottom temperature sensor is an NTC thermistor, which abuts against the bottom of the metal inner pot, and the temperature data of the inner pot can be converted into an electrical signal. In addition, in order to facilitate acquiring the boiling point temperature value, a top temperature sensor may be provided on the cooking utensil for obtaining the boiling point temperature value. Specifically, in one embodiment, the top temperature sensor is an NTC thermistor, which is provided on the pot lid of the cooking utensil, and the probe extends into the cooking cavity defined by the inner pot and the pot lid, and the boiling point temperature value is obtained by obtaining the temperature data in the cooking cavity and converting it into an electrical signal.
S03: controlling the wind generated by the air supply device to blow toward the outer wall of the inner pot to form a wind flow, and the wind flow is heated by the outer wall of the inner pot and/or the heating device to form a hot wind flow, and the hot wind flow is linked with the heating device to control the water absorption temperature in the inner pot to a set temperature; and the set temperature is not greater than the first temperature.

It should be understood that the air supply device includes but is not limited to a fan, an air pump, etc., and the air supply device is connected to a control system of the cooking utensil, and can be started according to the instructions of the control system to generate wind and blow toward the outer wall of the inner pot to form a wind flow.

When the wind flow contacts the outer wall of the inner pot or the heating device, it may exchange heat with the contact object and be heated into a hot wind flow; it should be understood that when the air supply device forms a hot wind flow, it is heated by the heat of the inner pot or the heating device, rather than the air supply device itself or other methods to form a hot wind flow. Therefore, in the water absorption stage, the air supply device can be linked with the heating device to control the wall temperature and water absorption temperature of the inner pot.

Based on the field of rice cooking, the water absorption stage, the heating device heats the inner pot in order to make the water absorption temperature in the inner pot reach the set temperature. At this time, the temperature of the inner pot fluctuates within a certain range. In some embodiments, the fluctuation range of the first temperature is between 45° C.-80° C., and the water absorption temperature is controlled below the set temperature of 45° C.; in some other embodiments, the fluctuation range of the first temperature can be at other temperature values. In one embodiment, the water absorption temperature is controlled below 55° C.

In some specific embodiments of the present application, the combined control includes:
according to the preset temperature range, the heating device is controlled to work intermittently in the water absorption stage;
when the heating device stops working, the air supply device is controlled to work;
when the first temperature is lower than the lower limit temperature value of the preset temperature range, the air supply device is controlled to stop working, and the heating device is controlled to resume heating.

As shown in FIG. 9, when the heating device works intermittently during the water absorption stage, the heating device stops heating when the temperature is higher than T2, and resumes heating when the temperature is lower than T1. The first temperature of the inner pot wall changes in the process of heating and cooling. In some specific implementations, the upper limit temperature (T2) and the lower limit temperature (T1) at different times can be set to be different, to form multiple different preset temperature intervals.

When only the heating device controls the temperature of the inner pot, as shown in FIG. 9, a curve c indicates the ideal temperature of the inner pot. Due to hysteresis, the temperature data measured by the bottom temperature sensor has a certain delay, showing the measured temperature in a curve a. During the cooking process, the heating device heats the inner pot with a certain power. When the temperature value is detected to exceed T2, the heating is stopped. The overall temperature of the rice water is uniform through the convection of cold and hot water in the pot. When the temperature is detected to drop to T1, the heating device resumes heating and continues to provide heat for the rice water mixture in the pot. By comparing the curve c with the curve a, it can be found that, ideally, the heating device should resume heating at time t3. However, in reality, the heating device does not resume heating until time t5. The heating device fails to start in time to continue to provide heat to the cooked rice that has been fully convected, causing the rice to heat up slowly. At this time, the water temperature in the inner pot slowly rises as shown by curve e.

As shown in FIG. 9, when the heating device stops working, the air supply device is controlled to work, and the measured temperature of the bottom temperature sensor drops as shown in a curve b. Specifically, under the combined control of the heating device and the air supply device, a curve d is the ideal temperature of the inner pot, and the measured temperature is shown as shown in curve b. Compared with the prior art, the curve b drops to the lower limit temperature value (T1) before the curve a. At this time, the heating device resumes heating at time t4, which is earlier than time t5. The heating device starts timelier to continue to provide heat for the rice with complete convection, causing the rice to heat up faster. At this time, the water temperature in the inner pot rises faster as shown in a curve f. After the heating device resumes heating, the air supply device stops working, to avoid heat loss and increasing the heating rate of rice water.

In some specific embodiments of the present application, the preset temperature interval has multiple:
each preset temperature interval has an upper limit temperature and a lower limit temperature;
compared with the upper limit temperatures of adjacent preset temperature intervals, the upper limit temperature value of the previous preset temperature interval is greater than the upper limit temperature value of the next preset temperature interval;
compared with the lower limit temperatures of adjacent preset temperature intervals, the lower limit temperature value of the previous preset temperature interval is greater than the lower limit temperature value of the next preset temperature interval.

For example, if the previous preset temperature interval is [50, 80], then the next preset temperature interval is [47, 70]. With such a setting, more heat can be added to the rice water when the temperature of the rice water is not high in a early stage, and less heat can be added when the temperature of the rice water is close to the set temperature in a later stage to avoid overheating.

In some specific embodiments of the present application, the combined control includes:
the heating device works intermittently in the water absorption stage, and the gas supply device works in the whole process in the water absorption stage, to control the first temperature to be within the preset temperature interval.

The whole process operation means that during the cooking process, the heating device not only works in the process of stopping heating, but also works in the heating process.

Specifically, as shown in FIG. 10, when only the heating device controls the temperature, the heating device resumes heating from time t5, the inner pot temperature rises rapidly, the inner pot temperature is shown as shown in the curve c, and the measured temperature is shown as shown in the curve a. When the air supply device is involved, the heating device resumes heating from time t4, the inner pot temperature rises rapidly, the inner pot temperature is shown as shown in the curve d, and the measured temperature is shown as shown in the curve b. Since the heat carried away by the wind flow is limited and the specific heat of the metal is small, it may not have a great impact on the heating rate.

In some specific embodiments of the present application,
at the beginning of cooking, the heating device is controlled to perform heating and the cooking utensils perform the preheating stage according to the preset cooking curve;
when the first temperature exceeds the set threshold in the preheating stage, the air supply device is controlled to work.

In the early stage of cooking, the temperature of the rice is low, and there is a preheating stage in which the heating device continues to perform heating. At this time, the air supply device is controlled to stop working, which can ensure that the preheating stage can heat up quickly. When the first temperature exceeds the set threshold, the air supply device is controlled to work again, to perform precise temperature control for the water absorption stage after the preset stage.

In some specific embodiments of the present application, the combined control includes:
acquiring the execution duration of the water absorption stage;
when the execution duration is greater than the preset time, controlling the air supply device to stop working.

During the heating process, the temperature of the rice water gradually increases as the heating is performed. When the temperature of the rice water is low, the temperature of the rice water in the pot can be quickly made uniform by convection under one heating and stopping heating. After the temperature of the rice water increases, the temperature difference between the local temperature and other parts of the rice inside is reduced under intermittent heating, and convection decreases. The internal rice mainly relies on internal heat conduction to make the temperature uniform. For this reason, if there is a hot air flow in the late stage of the water absorption stage, there is a possibility that the temperature of the rice water in the pot may not be evenly transferred and the heating may be resumed, resulting in the possibility that the water absorption temperature in the pot exceeds the preset temperature. After exceeding the water absorption temperature, the starch on the surface of the rice begins to gelatinize, and water absorption becomes poor, resulting in a reduced taste of the rice.

For this purpose, in a specific embodiment of the present application, the combined control between the air supply device and the heating device can be performed in the early stage without performing air supply in the late stage of the water absorption stage, to improve the accuracy of temperature control; for example, when the execution duration of the water absorption stage is less than ½ of the total water absorption time, the linked control is performed. The preset time can be specifically set according to the actual situation.

For the same reason, combined control can be performed by the working times of the heating device. In some specific embodiments, the combined control includes:
getting the working times of the heating device in the water absorption stage;
when the heating device is executed to the preset times, the air supply device is controlled to stop working.

The more times the heating device works, the more heat is provided to the rice water in the inner pot, and the higher the temperature of the rice water in the inner pot is. For this reason, combined control can be performed by controlling the working times of the heating device; specifically, the working times of the heating device are the times the heating device completes heating of the inner pot, or a working cycle of the heating device, and a working cycle may include a fixed number of heating times (one or more) and a fixed number of stopping times (one or more).

In some specific embodiments, the combined control includes:
acquiring the execution status of the heating device, when the heating device stops heating, starting the air supply device to work, getting the working time of the air supply device, and when the working time exceeds the preset time, performing a natural cooling process.

By starting the air supply device before stopping heating, the temperature drop can be accelerated. By stopping the air supply device after stopping heating, natural cooling can be performed to ensure that the temperature inside the inner pot is uniform after convection and heat transfer, and the heating device resumes heating. The above scheme takes into account both rapid heating and uniform temperature.

In some specific embodiments, the combined control includes:
obtaining the execution status of the heating device, when the heating device stops heating, starting the air supply device, obtaining the working time of the air supply device, and when the working time exceeds the preset time, performing the natural cooling process.

In the above embodiment, the air supply device is started in the early stage to perform natural cooling, which is applied in the later stage of the water absorption stage. As mentioned above, in the later stage of the water absorption stage, the heat is transferred more by the heat conduction of the rice water, so the temperature drop rate of the inner pot in the later stage may decrease, and it may take a longer time to reach the lower temperature limit. For the later stage of the water absorption stage, in order to avoid the air supply device starting to work when the temperature of the rice water in the inner pot is not evenly conducted, causing the heating device to resume heating in advance and causing the rice water temperature to be higher than the set temperature of the water absorption. By obtaining the execution state of the heating device, when the heating device stops heating, the air supply device is started to work, and the working time of the air supply device is obtained. When the working time exceeds the preset time, the natural cooling process is performed. It can make the temperature drop faster in the early stage when the heating device stops heating, and slower in the later stage, to balance the contradiction between temperature accuracy and over-temperature problem.

In the present application, if the above-mentioned air supply device does not participate the operation, the temperature of the inner pot is mainly controlled by the heating device. When the heating device is working, the inner pot heats up quickly, radiates and conducts heat to the external medium. From the distribution of the medium inside and outside the inner pot and itself, a mixture of rice and water is in the inner pot, and the specific heat of water is large, during the heating process, a large amount of heat needs to be absorbed to heat up. The inner pot is metal. Compared with water, the specific heat of metal is smaller than that of water, and the thermal conductivity is better than that of water. It can heat up faster and can conduct heat to other positions of the inner pot. The outside of the tank body is an air layer. The specific heat of the air layer is larger than that of metal and smaller than that of water. It is easier to heat up than water, but more difficult to heat up than metal. The thermal conductivity of the air layer is smaller than that of metal and water, and it has certain heat preservation properties. There are multiple layers of media between the bottom temperature sensor and the rice, which can be the inner pot, air layer, sensor housing, thermistor, etc.; thus, the temperature value detected by the bottom temperature sensor has a certain hysteresis, and cannot reflect the temperature of the inner pot well, nor can it reflect the temperature of the rice and water inside the inner pot well, and the measured temperature value has a certain gap with the inner pot temperature and the rice and water temperature inside the inner pot. In comparison, due to the fast temperature rise and good thermal conductivity of the inner pot, the measured temperature is closer to the temperature of the metal inner pot, and there is a larger error with the temperature of the rice and water in the inner pot.

In the actual cooking process, the temperature of the rice in the pot needs to be maintained at a certain temperature value in some cooking stages. Due to the existence of the above-mentioned temperature control error, it is necessary to control the heating device to intermittently heat the inner pot. When the heating device is heated, the temperature of the inner pot rises rapidly first, and the heat is first transferred to the rice water in contact with the inner pot, and the temperature of this part of the rice water rises first. In order to avoid the problem of overheating of the part of the rice water in contact with the inner pot, it is necessary to control the heating device to stop heating, and the hot and cold water in the pot body convect to make the temperature of the rice water in the inner pot uniform. During the convection process, the heat of the inner pot is absorbed by the rice water, and the temperature drops rapidly. However, due to the hysteresis of the temperature measured by the external temperature sensor, it cannot quickly reflect the actual temperature of the inner pot, resulting in the delay of the time node for resuming heating, and then the heating device cannot be started in time to heat the rice after convection, resulting in a slow heating speed of the rice.

Specifically, in one embodiment, as shown in FIG. 9, the curve c is the inner pot temperature of the bile body. Due to hysteresis, the temperature data measured by the bottom temperature sensor has a certain delay, showing the measured temperature in the curve a. During the cooking process, the heating device heats the inner pot with a certain power. When the temperature value detected exceeds T2, the heating is stopped, and the overall temperature of the rice water is uniform through the convection of cold and hot water in the bile. When the temperature is detected to drop to T1, the heating device resumes heating and continues to provide heat for the rice water mixture in the bile. By comparing the curve c and the curve a, it can be found that the heating device should resume heating at time t3 in an ideal state, but in fact, the heating device waits until time t5 to resume heating. The heating device fails to start in time to continue to provide heat to the rice that is fully convected, resulting in a slow heating rate of the rice. At this time, the water temperature in the bile body rises slowly as shown in a curve e.

In the embodiment shown in FIG. 8, when the air supply device is used to make the air layer outside the inner pot flow, the heat transfer of the air layer at this time relies more on convection, which improves the heat transfer capacity of the air layer and reduces the heat preservation property of the air layer. The temperature sensor at the bottom can drop to the preset temperature faster during the cooling process, and the heating device can resume heating in advance, to provide heat for the rice in the inner pot in time, and then quickly heat up. Here, the hot air flow is formed by the heating of the outer wall of the inner pot and/or the heating device, so the inner pot temperature will also drop synchronously with the bottom temperature sensor, avoiding the possibility of the inner pot temperature being heated by the hot air flow and the temperature rising due to the direct delivery of the hot air flow. Since the specific heat of the air flow is still less than that of water and the thermal conductivity is still worse than that of water, most of the heat is still absorbed by water during the temperature drop, and the heat taken away by the air flow is still limited, so the heat loss is not large, and it will not affect the temperature rise of the rice water in the inner pot, so the temperature measurement accuracy of the bottom temperature sensor can be improved by the air flow.

Specifically, as shown in FIG. 9, under the combined control of the heating device and the air supply device, the curve d is the ideal temperature of the inner pot, and the measured temperature is shown as a curve b. Compared with the prior art, the curve b drops to the preset temperature T1 before curve a. At this time, the heating device resumes heating at time t4, earlier than time t5. The heating device starts timelier to continue to provide heat to the rice that has been fully convected, causing the rice to heat up faster. At this time, the water temperature in the inner pot rises more quickly as shown in a curve f.

Taking the water absorption stage as an example, assuming that the total water absorption time is 10 minutes, in the prior art, if the heating device heats 10 times in 10 minutes, the above embodiments can increase the heating times of the heating device to more than 10 times, to rapidly increase the water absorption temperature of the inner pot.

In summary, the air flow of the air supply device forms a hot air flow under the heating of the outer wall of the inner pot and/or the heating device, and the heating device and the air supply device are combined to control the water absorption temperature in the inner pot to the set temperature T2, which can make the temperature control more accurate and increase the water absorption temperature in the inner pot more quickly.

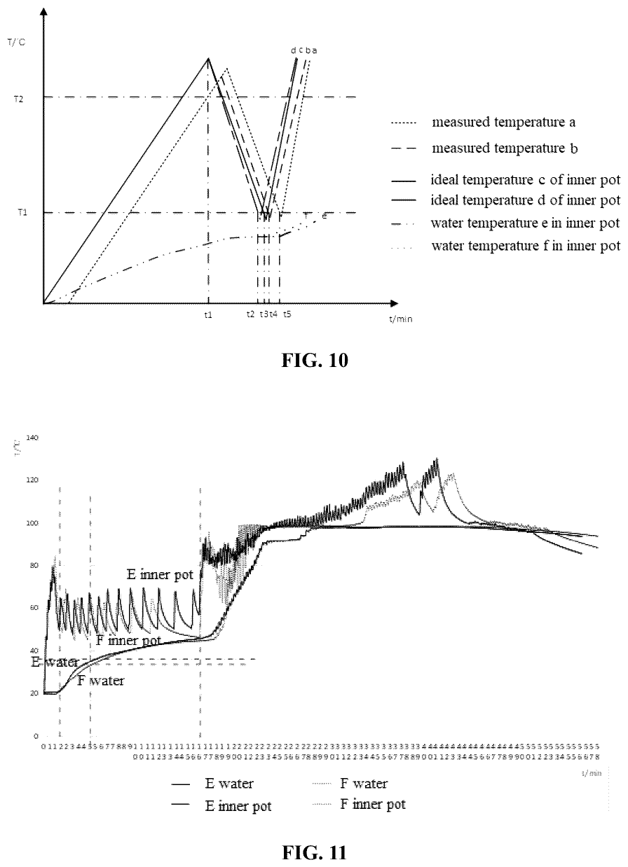

Referring to the temperature curve shown in FIG. 11, in a specific embodiment of the present application, the experimental data are as follows:

| Time/min(s) | E water | E inner pot | F water | F inner pot |
|---|---|---|---|---|
| 1 | 20.831 | 71.651 | 19.96 | 84.338 |
| 2 | 21.228 | 49.579 | 21.483 | 55.936 |
| 2 | 21.67 | 64.856 | 22.198 | 51.821 |
| 2 | 22.324 | 61.132 | 22.948 | 48.204 |
| 2 | 23.932 | 49.723 | 24.289 | 67.706 |
| 2 | 24.185 | 50.001 | 24.414 | 69.082 |
| 3 | 25.605 | 66.768 | 25.103 | 61.547 |
| 3 | 29.842 | 47.731 | 27.428 | 46.782 |
| 3 | 30.5 | 63.742 | 27.897 | 45.16 |
| 4 | 32.088 | 51.36 | 29.526 | 63.961 |
| 4 | 32.646 | 48.31 | 30.086 | 58 |
| 4 | 33.095 | 64.925 | 30.708 | 53.541 |
| 5 | 34.582 | 48.397 | 32.632 | 45.334 |
| 5 | 35.023 | 67.046 | 33.058 | 58.893 |
| 5 | 35.374 | 59.991 | 33.425 | 64.811 |
| 6 | 36.483 | 48.383 | 34.833 | 50.842 |
| 6 | 36.763 | 65.448 | 35.246 | 48.994 |
| 6 | 37.423 | 55.032 | 35.952 | 46.316 |
| 6 | 37.716 | 51.716 | 36.312 | 62.974 |
| 7 | 37.966 | 49.37 | 36.668 | 57.673 |
| 7 | 38.207 | 68.937 | 37.019 | 53.795 |
| 8 | 38.954 | 51.512 | 38.299 | 47.305 |
| 8 | 39.131 | 49.377 | 38.637 | 61.868 |
| 8 | 39.199 | 56.933 | 38.741 | 62.545 |
| 8 | 39.315 | 69.211 | 38.895 | 60.786 |
| 9 | 40.384 | 49.945 | 40.184 | 48.763 |
| 9 | 40.524 | 69.567 | 40.368 | 48.062 |
| 9 | 40.796 | 62.479 | 40.548 | 65.161 |
| 10 | 41.712 | 50.225 | 41.53 | 51.415 |
| 11 | 41.876 | 69.812 | 41.696 | 50.528 |
| 11 | 42.467 | 55.667 | 42.224 | 48.342 |
| 12 | 43.058 | 50.183 | 42.786 | 56.225 |
| 12 | 43.193 | 69.399 | 42.924 | 54.671 |
| 14 | 44.426 | 50.262 | 43.863 | 48.859 |
| 14 | 44.508 | 67.992 | 43.953 | 48.601 |
| 16 | 45.401 | 50.435 | 44.605 | 46.937 |
| 16 | 45.472 | 69.019 | 44.645 | 46.813 |
| 16 | 45.834 | 56.942 | 44.779 | 46.477 |
| 16 | 45.85 | 58.535 | 44.769 | 46.443 |

the data of group E are the relevant data of the water absorption stage under combined control, E water is the measured temperature of rice water in the inner pot under combined control, and E inner pot is the inner pot wall temperature data measured by the bottom temperature sensor under combined control; the data of group F are the relevant data of the water absorption stage under non-combined control, F water is the measured temperature of rice water in the inner pot under non-combined control, and F inner pot is the inner pot wall temperature data measured by the bottom temperature sensor under non-combined control.

It can be seen that the moment when the E inner pot heating device resumes heating is faster than that of the Finner pot, and the water temperature of E water rises faster than that of F water. For example, at 6 minutes, the water temperature of group E is 34.582° C., and the water temperature of group F is 32.632° C. It can be seen that the water temperature of group E rises faster. From the change law of inner pot temperature, within 16 minutes, group F is intermittently heated 7 times, and group E is intermittently heated 14 times, which is significantly more.

In some embodiments of the present application, the air supply device is a fan, and the control of the fan includes:
controlling the fan to work at a preset speed.

The preset speed can be 1500 r/min-10000 r/min, and the noise of the fan during operation can be controlled within a reasonable range, improving the user experience.

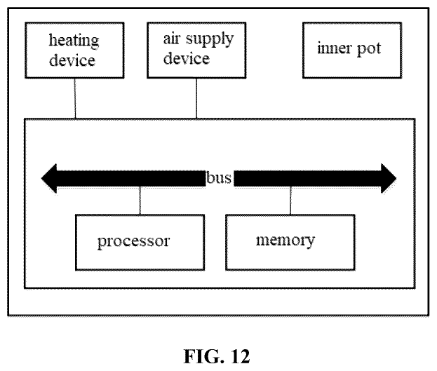

In some embodiments of the present application, with reference to FIG. 12, a cooking utensil is also proposed, including an inner pot for cooking rice, a heating device, a bottom temperature sensor, an air supply device, a memory and a processor, and the memory stores a computer program that can be run on the processor; when the processor executes the program, the steps in any of the above methods are implemented.

In one embodiment, the heating device can be an electromagnetic heating coil, and the inner pot is heated by the alternating magnetic field generated by the electromagnetic heating coil. In another embodiment, the heating device can be a heating coil, which generates heat by energizing the internal heating tube, and then conducts the heat to the rice in the inner pot through heat conduction.

Referring to FIG. 7, a structural diagram of an embodiment of the electric rice cooker disclosed in the present application is shown; the rice cooker includes a pot body 10, a pot lid 20, a heat-insulating inner cover 101, an inner pot 30 for cooking rice, a heating device 105, and a fan 40. The pot body 10 is provided with a receiving cavity 106, the inner pot 30 is placed in the receiving cavity 106 and is located on the heating device 105, and the pot lid 20 is buckled to close the receiving cavity 106 and the inner pot 30 to form a cooking cavity 301.

The places not described in this application can be realized by adopting or drawing on existing technologies.

The various embodiments in this specification are described in a progressive manner, and the same and similar parts between the various embodiments can be referred to each other, and each embodiment focuses on the differences from other embodiments.

All or part of the steps of the above-mentioned method embodiment can be completed by hardware related to program instructions, and the aforementioned program can be stored in a computer-readable storage medium. When the program is executed, the steps of the above-mentioned method embodiment are executed; and the aforementioned storage medium includes: various media that can store program codes, such as mobile storage devices, read-only memory (ROM), magnetic disks or optical disks.

Or, if the above-mentioned integrated unit of the present application is implemented in the form of a software function module and sold or used as an independent product, it can also be stored in a computer-readable storage medium. Based on this understanding, the embodiment of the present application can be essentially or partly reflected in the form of a software product, which is stored in a storage medium and includes several instructions for a cooking pot (which can be a rice cooker, an electric stew pot, or an electric pressure cooker, etc.) to execute all or part of the methods described in each embodiment of the present application. The aforementioned storage medium includes: various media that can store program codes, such as mobile storage devices, ROMs, magnetic disks or optical disks.

The above description is only an embodiment of the present application and is not intended to limit the present application. The present application may have various modifications and variations. Any modification, equivalent substitution, improvement, etc. made within the spirit and principle of the present application shall be included in the scope of the claims of the present application.

1. A cooking method for making rice with a cooking utensil, wherein the cooking utensil comprises an inner pot for cooking rice, a heating device and a cooling device, and the cooking method comprises following steps:
acquiring a rice cooking instruction, executing a preset cooking curve to a rice stewing stage, and obtaining an execution status of the rice stewing stage;
when the execution status meets preset conditions, controlling the cooking utensil to enter an elasticity-increasing stage;
wherein the elasticity-increasing stage comprises controlling the cooling device to cool cooked rice in the inner pot, a temperature of the cooked rice drops to a preset temperature and/or a cooling time reaches a preset time, and the cooked rice shrinks due to cold;
the preset cooking curve comprises a heat preservation stage, and the cooking method further comprises following steps:
in the elasticity-increasing stage, controlling a temperature value of a bottom of the inner pot after a cooling process and the temperature value is greater than a heat preservation threshold of the heat preservation stage;
In the heat preservation stage, the temperature of the cooked rice is maintained at the heat preservation threshold, and the temperature value of the bottom of the inner pot after the cooling process is 70° C.-98° C.

2. The cooking method for making rice according to claim 1, wherein the preset conditions include:
when the rice stewing stage ends; or, when the rice stewing stage is executed to a set time; or, when a first temperature of the bottom of the inner pot reaches the set temperature during the rice stewing stage.

3. The cooking method for making rice according to claim 1, wherein the preset cooking curve includes a boiling stage, and that obtaining the execution status through the execution duration of the rice stewing stage includes following steps:
obtaining a change state of a first temperature at the bottom of the inner pot;
when the first temperature is greater than a first temperature limit value, determining to execute the preset cooking curve to the rice stewing stage; wherein the first temperature limit value is greater than a boiling point temperature value of the boiling stage;
obtaining the execution duration of the rice stewing stage to obtain the execution status of the rice stewing stage.

4. The cooking method for making rice according to claim 1, wherein,
there is a natural cooling stage between the heat preservation stage and the elasticity-increasing stage, and in the natural cooling stage, the first temperature of the bottom of the inner pot is naturally cooled from the temperature value after the elasticity-increasing stage ends to the heat preservation threshold.

5. The cooking method for making rice according to claim 1, wherein, under the cooling process, that controlling the cooling device includes:
controlling the cooling device to stop working after the first temperature at the bottom of the inner pot drops to a preset temperature value;
controlling the heating device to stop working and obtaining the change state of the first temperature, and when the first temperature is higher than the temperature threshold, controlling the cooling device to resume working.

6. The cooking method for making rice according to claim 1, wherein the cooling device includes a cooling fan, and that controlling the cooling fan includes:
controlling the cooling fan to work at a preset speed to cool an outer wall of the inner pot.

7. The cooking method for making rice according to claim 1, wherein,
obtaining a temperature limit value of the stewing stage;
when the temperature limit value is greater than a first value, the cooling device executes a first preset time to cool the rice in the inner pot;
when the temperature limit value is greater than or equal to a second value, the cooling device executes a second preset time to cool the rice in the inner pot;
the first value is greater than the second value, and the first preset time is less than the second preset time.

8. The cooking method for making rice according to claim 1, wherein,
the temperature of the rice drops to a preset temperature, the preset temperature is 3° C. to 10° C.;
and/or;
the cooling time reaches a preset time, and the preset time is 2 to 10 minutes.

9. A cooking utensil, comprising an inner pot for cooking rice, a heating device, a cooling device capable of cooling an outer wall of the inner pot, a memory and a processor, wherein the memory stores a computer program for running on the processor; when the processor executes the program, following steps are implemented:
acquiring a rice cooking instruction, executing a preset cooking curve to a rice stewing stage, and obtaining an execution status of the rice stewing stage;
when the execution status meets preset conditions, controlling the cooking utensil to enter an elasticity-increasing stage;
wherein, the elasticity-increasing stage includes controlling the cooling device to cool the rice in the inner pot, the temperature of the rice drops to a preset temperature and/or the cooling time reaches a preset time, and the rice shrinks due to cold;
the preset cooking curve includes a heat preservation stage, and the cooking method also includes following steps:
in the elasticity-increasing stage, controlling a temperature value of a bottom of the inner pot after a cooling process and the temperature value is greater than a heat preservation threshold of the heat preservation stage;
in the heat preservation stage, a temperature of the rice is maintained at the heat preservation threshold, and the temperature value of the bottom of the inner pot after the cooling process is 70° C.-98° C.
